(19) United States
(12) Patent Application Publication
(10) Pub. No.: US 2017/0242141 A1
(43) Pub. Date: Aug. 24, 2017

(54) SEISMIC MIGRATION USING AN INDEXED MATRIX

(71) Applicant: CGG SERVICES SAS, Massy Cedex (FR)

(72) Inventors: Julien COTTON, Paris (FR); Eric FORGUES, Bures-sur-Yvette (FR)

(21) Appl. No.: 15/503,773

(22) PCT Filed: Sep. 8, 2015
(86) PCT No.: PCT/IB2015/002011

§ 371 Date: Feb. 14, 2017

Related U.S. Application Data
(60) Provisional application No. 62/047,072, filed on Sep. 8, 2014.

(51) Int. Cl. G01V 1/30; G01V 1/28; G01V 1/36

(52) U.S. Cl. CPC G01V 1/30; G01V 1/36; G01V 1/282; G01V 2210/51

(57) ABSTRACT

Systems and methods for performing seismic migration using an indexed matrix are disclosed. The method includes receiving a seismic trace from a receiver, determining a discretized position of the receiver, and determining a discretized position of a seismic source. The method also includes determining a set of migration indexes based on a matrix, the discretized position of the receiver, and the discretized position of the seismic source, and determining a set of amplitude weights based on the matrix, the discretized position of the receiver, and the discretized position of the seismic source. The method further includes migrating the seismic trace based on the set of migration indexes and the set of amplitude weights.

### CROSS-REFERENCE TO RELATED APPLICATION

This application claims the benefit of U.S. Provisional Application Ser. No. 62/047,072 filed on Sep. 8, 2014, which is incorporated by reference in its entirety for all purposes.

### TECHNICAL FIELD

The present disclosure relates generally to seismic exploration and, more particularly, to seismic migration using an indexed matrix.

### BACKGROUND

In the oil and gas industry, seismic exploration techniques are commonly used to aid in locating subsurface deposits of oil, gas, and other useful minerals. Because drilling involves high costs and high risks, seismic surveys are used to produce an image of subsurface geological structures. While the image may not directly show the location of oil or gas, those trained in the field can use such images to more accurately predict the location of oil and gas and thus reduce the chance of drilling a non-productive well.

Seismic exploration, whether on land or at sea, is a method of detecting geologic structures below the surface of the earth by analyzing seismic energy that has interacted with the geologic structures. Generally, a seismic energy source imparts a force at or near the surface of the earth. The resulting mechanical stress propagates according to the elastic properties of the subsurface, and is at least partially reflected by subsurface seismic reflectors (interfaces between geologic structures that have different acoustic impedances). Seismic receivers, placed at or near the earth's surface, within bodies of water, or below the earth's surface in wellbores, record the ground motion or fluid pressure resulting from the reflection. The recordings are processed to generate information about the location and physical properties of the subsurface geologic structures that reflected the seismic energy. For example, recordings may be processed to generate a 2D or 3D image of the subsurface seismic reflectors.

In many survey areas, the speed at which seismic energy moves through the subsurface, known as the seismic velocity, varies with location and/or depth below the surface. In addition, in many survey areas, seismic reflectors are not positioned horizontally, but at a variety of dip angles. Such variable seismic velocities and dipping seismic reflectors cause images produced from raw seismic data to show seismic reflectors at incorrect locations. Such images may also show reflected seismic energy from a seismic reflector smeared across a surface such as a hyperbolic diffraction curve, rather than at a single point. As a result, during processing, some form of seismic migration is applied to the recorded data to focus energy spread out through the raw seismic data and to accurately position the subsurface seismic reflectors at the correct subsurface positions. For example, seismic migration may compute a weighted sum of the energy along a diffraction curve and apply a time correction to shift the summed energy in time.

Seismic migration may be applied before or after normal moveout (NMO) and stacking of the seismic traces. For example, in many survey operations, the source and receiver are not positioned in the same location, but are offset by some distance. During processing, seismic traces that share a common midpoint between the seismic source and the seismic receiver, known as a common-midpoint gather, are combined to form a stacked data trace that simulates a zero-offset seismic trace at the common midpoint. In post-stack migration, a migration technique is applied to the stacked data. In pre-stack migration, a migration technique is applied to each individual seismic trace and the migrated results are then stacked with the other migrated traces. Pre-stack migration often produces more accurate results than post-stack migration. However, pre-stack migration is more computationally expensive than post-stack migration.

In traditional survey operations, seismic migration is applied to the entire data set for the survey operation. Typically, this post-survey seismic migration is performed at a data-processing facility after the entire data set for the survey operation has been gathered in the field. Acquiring the entire data set and processing it may take several months. In some survey operations, fast-track processing is applied in the field after a block of seismic data is collected. However, acquiring a block of seismic data may take several weeks, and processing the data may take up to a week, even when post-stack migration techniques are used. As a result, there is a substantial time delay between acquiring raw seismic data in the field and producing analyses or images using migrated seismic data. Thus, such analyses and images are not available in the field for use in detecting failures of survey equipment or other errors in data acquisition.

Accordingly, there is a need for systems and methods that can perform seismic migration in real time or near real time in the field.

### SUMMARY

In accordance with one or more embodiments of the present disclosure, a method for performing seismic migration using an indexed matrix includes receiving a seismic trace from a receiver, determining a discretized position of the receiver, and determining a discretized position of a seismic source. The method also includes determining a set of migration indexes based on a matrix, the discretized position of the receiver, and the discretized position of the seismic source, and determining a set of amplitude weights based on the matrix, the discretized position of the receiver, and the discretized position of the seismic source. The method further includes migrating the seismic trace based on the set of migration indexes and the set of amplitude weights.

In accordance with another embodiment of the present disclosure, a seismic data acquisition system includes a processor, a memory communicatively coupled to the processor, a receiver configured to transform seismic signals into seismic signal data, and a seismic source. The system also includes a matrix stored in the memory and instructions stored in the memory that, when executed by the processor, cause the processor to receive a seismic trace from a receiver, determine a discretized position of the receiver, determine a discretized position of a seismic source, determine a set of migration indexes based on a matrix, the discretized position of the receiver, and the discretized position of the seismic source, determine a set of amplitude weights based on the matrix, the discretized position of the receiver, and the discretized position of the seismic source, and migrate the seismic trace based on the set of migration indexes and the set of amplitude weights.

In accordance with another embodiment of the present disclosure, a non-transitory computer-readable medium includes instructions that, when executed by a processor, cause the processor to receive a seismic trace from a receiver, determine a discretized position of the receiver, determine a discretized position of a seismic source, determine a set of migration indexes based on a matrix, the discretized position of the receiver, and the discretized position of the seismic source, determine a set of amplitude weights based on the matrix, the discretized position of the receiver, and the discretized position of the seismic source, and migrate the seismic trace based on the set of migration indexes and the set of amplitude weights.

### BRIEF DESCRIPTION OF THE DRAWINGS

For a more complete understanding of the present disclosure and its features and advantages, reference is now made to the following description, taken in conjunction with the accompanying drawings, which may include drawings that are not to scale and wherein like reference numbers indicate like features, in which:

FIG. 1 illustrates a graph of an example seismic trace in accordance with some embodiments of the present disclosure;

FIG. 2 illustrates a graph of two-way travel times to sample reflectors for a shot gather, in accordance with some embodiments of the present disclosure;

FIG. 3 illustrates a graph of migrated two-way travel times to sample reflectors for a shot gather, in accordance with some embodiments of the present disclosure;

FIG. 4 illustrates an example indexed matrix 400 used to accelerate a migration computation in accordance with some embodiments of the present disclosure;

FIG. 5 illustrates a flow chart of an example method 500 for performing seismic migration using an indexed matrix in accordance with some embodiments of the present disclosure; and

FIG. 6 illustrates an elevation view of an example seismic exploration system 600 configured to perform seismic migration using an indexed matrix in accordance with some embodiments of the present disclosure.

### DETAILED DESCRIPTION

The present disclosure is directed to seismic migration using an indexed matrix. As discussed above, seismic migration is used to focus energy spread out through the raw seismic data and to accurately position the subsurface seismic reflectors at the correct subsurface positions. In conventional pre-stack time migration, a set of time corrections (migration indexes) and amplitude weights is calculated based on the exact positions of the source and receiver for each seismic trace and a velocity model of the survey area, and applied to the seismic trace recorded by the receiver prior to stacking traces. This calculation requires significant time and substantial computing power to accomplish, and often dominates the seismic migration process. In embodiments of the present disclosure, seismic migration is accelerated using a precomputed matrix of indexes and amplitude weights for a set of predefined discrete source and receiver positions. A seismic migration process may discretize the source and receiver position for a particular seismic trace, then look up the corresponding indices and amplitude weights in the precomputed matrix and apply them to the seismic trace in real time or near real time in the field.

The migrated seismic trace may be used to build and display a 2D or 3D image of the subsurface during the survey operation. For example, at the beginning of a survey, a 3D subsurface image may be initialized to all zero values. As each seismic trace is received, the samples constituting the trace may be migrated and added to the 3D subsurface image. The 3D subsurface image that results may be displayed to operators of the survey for use in field-quality control of the survey operation.

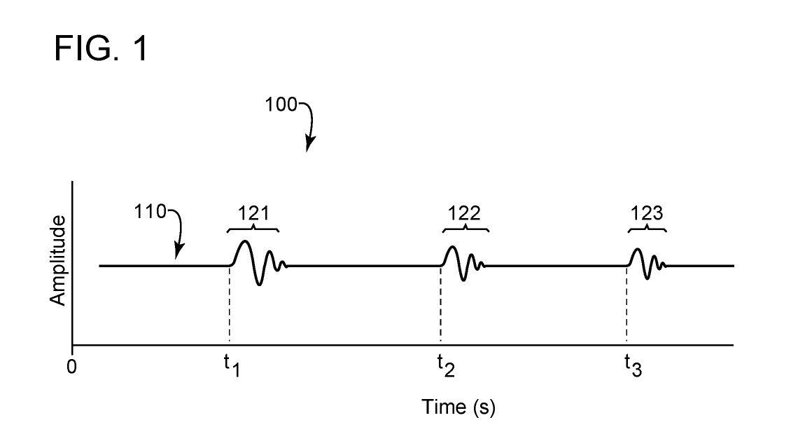

FIG. 1 illustrates a graph 100 of an example seismic trace in accordance with some embodiments of the present disclosure. Graph 100 represents the amplitude of seismic trace 110 received by a particular receiver as a function of time. For example, seismic trace 110 may represent a trace received by a receiver at a distance xᵣ to the north of a seismic source. Seismic trace 110 may include portion 121 that begins at time t₁. Portion 121 may represent a reflection of the seismic signal generated by the seismic source from a first subsurface reflector, in which case t₁ represents the two-way travel time of the seismic signal from the seismic source to the first subsurface reflector and from the first subsurface reflector to the receiver. Similarly, seismic trace 110 may include portion 122 that begins at time t₂. Portion 122 may represent a reflection of the seismic signal generated by the seismic source from a second subsurface reflector, in which case t₂ represents the two-way travel time of the seismic signal from the seismic source to the second subsurface reflector and from the second subsurface reflector to the receiver. Seismic trace 110 may also include portion 123 that begins at time t₃. Portion 123 may represent a reflection of the seismic signal generated by the seismic source from a third subsurface reflector, in which case t₃ represents the two-way travel time of the seismic signal from the seismic source to the third subsurface reflector and from the third subsurface reflector to the receiver.

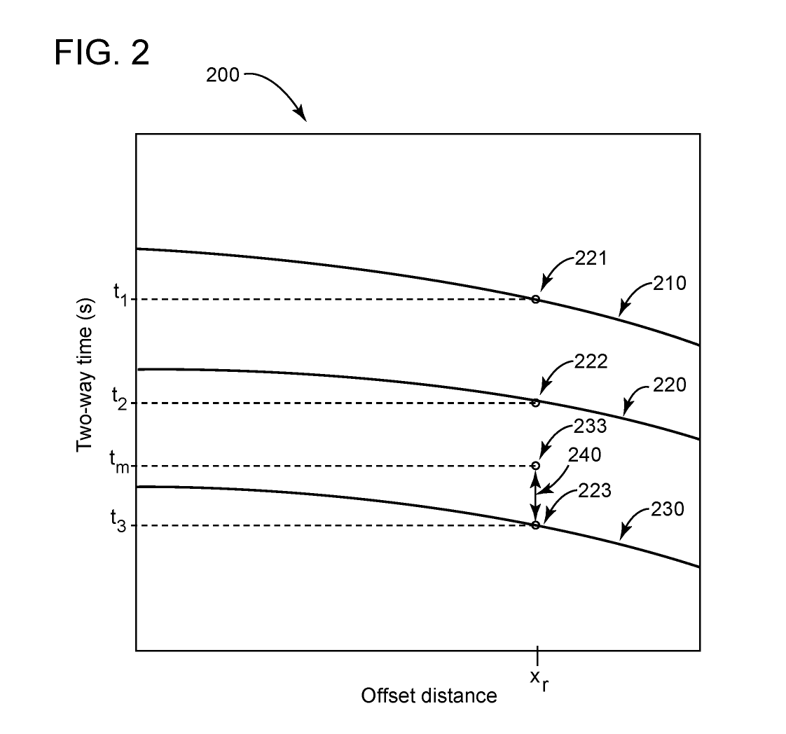

FIG. 2 illustrates a graph 200 of two-way travel times to sample reflectors for a shot gather, in accordance with some embodiments of the present disclosure. For example, graph 200 may include one or more reflection or diffraction curves (hereinafter referred to as reflection curves) representing the two-way travel time from a seismic source to a subsurface reflector or diffracting point (hereinafter referred to as a subsurface reflector) and from the subsurface reflector to a receiver as a function of the offset distance between the seismic source and the receiver. For example, graph 200 may include reflection curve 210 representing the two-way travel time from a seismic source to the first subsurface reflector and from the first subsurface reflector to a receiver as a function of the offset distance between the seismic source and the receiver. As an example, point 221 on reflection curve 210 may correspond to time t₁ in graph 100, where the seismic source and receiver were separated by an offset distance xᵣ. Similarly, graph 200 may include reflection curve 220 representing the two-way travel time from a seismic source to a second subsurface reflector and from the second subsurface reflector to a receiver as a function of the offset distance between the seismic source and the receiver. Point 222 on reflection curve 220 may correspond to time t₂ in graph 100. Graph 200 may also include reflection curve 230 representing the two-way travel time from a seismic source to a third subsurface reflector and from the third subsurface reflector to a receiver as a function of the offset distance between the seismic source and the receiver. Point 223 on reflection curve 230 may correspond to time t₃ in graph 100.

In practice, seismic traces contain noise that may interfere with identification and visualization of the subsurface reflectors. Multiple seismic traces may be combined into a single stacked trace with a higher signal-to-noise ratio. However, because the points on reflection curves 210, 220, and 230, each of which corresponds to reflections from a single subsurface reflector, do not fall at the same time in each trace, simply summing the samples taken at the same point in time from each raw seismic trace in a shot gather fails to fully combine the energy reflected by each subsurface reflector. Seismic migration corrects the times of each sample in each seismic trace to position the points corresponding to reflections from a single subsurface reflector at the proper time. Once the trace samples have been migrated in time, a weighted sum of the samples at each migrated time is performed to create a set of migrated data traces that can be incorporated into the 2D or 3D subsurface image. The value of the proper time correction and the proper weighting value used in the weighted sum are determined in part by the velocity of seismic signals through the subsurface in the survey area. Because the exact velocity may not be known at all locations, in some embodiments, the velocity at which seismic signals propagate through the subsurface in the survey area may be estimated using a velocity model. The velocity model may include a single predicted velocity for all locations. In some embodiments, the velocity model may be smooth or may vary as a function of depth below the surface. Such a velocity model may represent a series of horizontal layers within the entire survey area. In some embodiments, the velocity model may also vary based on one or more factors such as surface location, direction of propagation, or other suitable factors. A velocity model may be defined by the survey operators, estimated based on previous surveys of the survey area, or calculated in any other suitable manner.

During processing, a set of time corrections for a seismic trace may be estimated based on the velocity model, the locations of the seismic source and the receiver, and the two-way time between the source, the reflector, and the receiver. For example, the two-way travel time from a source at location S to a subsurface reflector and then to a receiver at location R may be modeled according to the following equation:

$$t = \sqrt{{t}_{0}^{2} + \frac{{( A - S )}^{2}}{{V}_{rms}^{2}}} + \sqrt{{t}_{0}^{2} + \frac{{( A - R )}^{2}}{{V}_{rms}^{2}}} \qquad ( 1 )$$

where
t=the total travel time from the source to a subsurface reflector and back to a receiver;
t₀=the one-way travel time from the surface location of the subsurface reflector to the subsurface reflector and back (i.e., the point being imaged);
A=the surface location directly above the subsurface reflector;
S=the location of the source;
R=location of the receiver; and
Vᵣₘₛ=the root-mean-square velocity at the subsurface reflector according to the velocity model.
   The modeled two-way travel time t and the two-way travel time to point A provides the time correction to be applied. Such a time correction is known as a migration index. For example, migration index 240 may be calculated based on the velocity model, the locations of the sources and receivers of the seismic traces represented by graph 200, the offset xᵣ between the seismic source and the receiver for seismic trace 110, discussed with reference to FIG. 1, and the time t₃. During processing, the sample contained in seismic trace 110 at time t₃ is shifted to time tₘ as a result of applying migration index 240.

In some embodiments, every sample of each recorded trace is migrated. In some embodiments, only samples needed to compute a particular image are migrated. For example, an operator may desire to view a particular inline or crossline section of the 3D subsurface image. As a result, the migration process may migrate only those traces that would contribute samples to the portions of the 3D subsurface image appearing on the desired section.

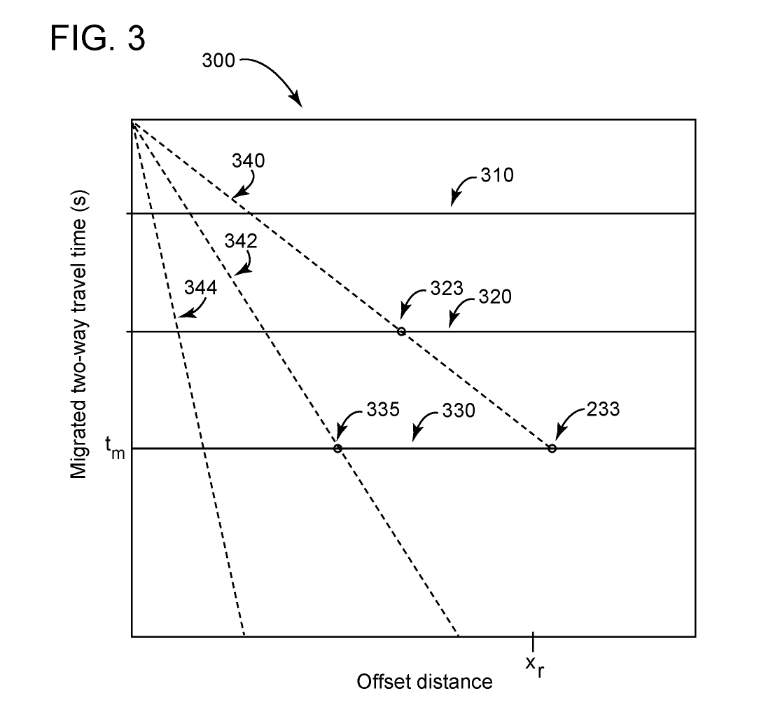

In some surveys, calculating and applying a migration index to each sample in each seismic trace of a shot gather improves the time alignment of the seismic energy in each seismic trace in the gather, as illustrated in FIG. 3. FIG. 3 illustrates a graph 300 of migrated two-way travel times to sample reflectors for a shot gather, in accordance with some embodiments of the present disclosure. For example, graph 300 may represent the result of calculating and applying a migration index to each sample of the seismic traces represented by FIG. 2. As a result, FIG. 3 represents the migrated two-way travel times from a seismic source to three subsurface reflectors and from the three subsurface reflectors to a receiver as a function of the offset distance between the seismic source and the receiver. For example, line 310 may represent the migrated two-way travel times corresponding to reflection curve 210, discussed with reference to FIG. 2. Line 320 may represent the migrated two-way travel times corresponding to reflection curve 220, discussed with reference to FIG. 2. Line 330 may represent the migrated two-way travel times corresponding to reflection curve 230, discussed with reference to FIG. 2. In some embodiments, lines 310, 320, and 330 may be straight horizontal lines, as depicted in FIG. 3. However, in operation, lines 310, 320, and 330 may be curved or irregular, and may be oriented non-horizontally, based on the accuracy of the velocity model, the accuracy of the positions of the seismic source and receiver, or other factors.

In operation, the migrated samples in each seismic trace in a shot gather are “stacked” to produce a stacked data trace that simulates a zero-offset seismic trace at the common midpoint. The combination of the traces may use a weighted sum of the samples from each trace by multiplying each sample by a weighting factor. For example, after migration, all the samples corresponding to migrated time tₘ, including the sample at point 233, may be combined in a weighted sum. The weighting factor for each sample is known as an amplitude weight.

The amplitude weight of each sample reflects the fact that more energy is reflected at the apex of a reflection curve (e.g., where the offset distance is small) than on the sides. The amplitude weight of each sample may also reflect the fact that the attenuation of the reflected energy from a subsurface reflector may depend on the angle at which the energy encounters the reflector. As a result, the amplitude weight is a function of at least the time of the sample, the offset distance between the seismic source and the receiver, and the velocity model. For example, lines 340, 342, and 344 may represent contours along which the amplitude weight is constant. Points 233 and 323, which lie along contour 323, may be assigned the same weight w₃. Point 335, which lies along contour 342, may be assigned a different weight. Although contours 340, 342, and 344 are illustrated as substantially straight lines in FIG. 3, any suitable amplitude weight function may be used.

In conventional seismic migration, the migration index and amplitude weight for each point in a seismic trace is calculated at the time the migration calculation is performed. Furthermore, the migration index and amplitude weight for each point is based on the exact position of the source and receiver for that seismic trace. For example, the position of each source and receiver may be determined using GPS at the time the trace is recorded. In some embodiments, the calculations required to determine the migration index and amplitude weight for each point in a seismic trace represent a significant fraction of the total time required to perform the migration.

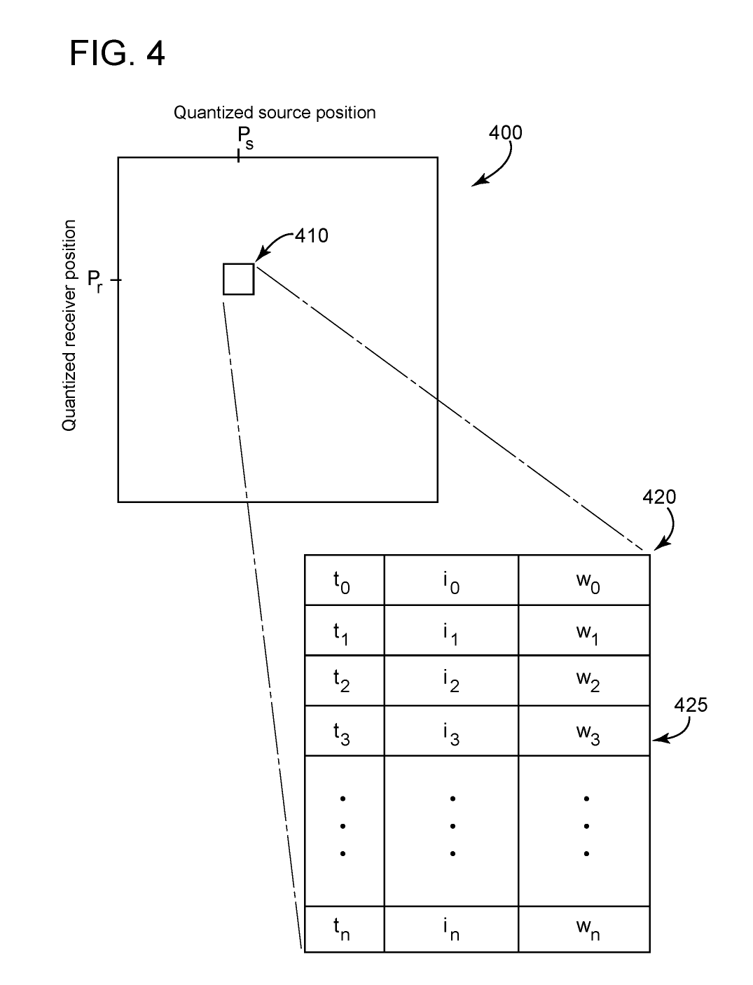

FIG. 4 illustrates an example indexed matrix 400 used to accelerate a migration computation in accordance with some embodiments of the present disclosure. Matrix 400 may be indexed by discretized positions of the source and the receiver. For example, cell 410 of matrix 400 may correspond to a seismic source position Pₛ and a receiver position Pᵣ. Discretized positions are selected in advance of computing matrix 400, and may correspond to expected or typical locations of sources or receivers during the survey operation. For example, in a land-based survey, the seismic sources and receivers may be positioned on a grid spaced approximately 8 meters apart. In such a survey, the discretized positions used to index matrix 400 may be approximately 8 meters apart, aligned with the grid, and covering the surface of the survey area. In a marine survey, the seismic sources may be positioned at a fixed distance behind the survey vessel, and the receivers may be positioned on streamers behind the survey vessel spaced approximately 25 meters apart. Because the course of the survey vessel and the time of each shot of the seismic source are known, the positions of the seismic sources and receivers may thus be predicted. In such a survey the discretized positions used to index matrix 400 may be approximately 25 meters apart, aligned to the expected positions of the sources and receivers, and covering the surface of the water in the survey area. Although the present disclosure discusses specific values of the spacing between discretized positions of the seismic source and receiver, any suitable spacing may be used.

Each cell of matrix 400 may contain a list of migration indexes and amplitude weights used to migrate a seismic trace. For example, cell 410 may include list 420, in which each row corresponds to a particular sample time. For example, row 425 may correspond to time t₃ at which the sample of point 233, discussed with reference to FIG. 2, was recorded. List 420 may include, for each sample time, a precomputed migration index and a precomputed amplitude weight. In some embodiments, the precomputed migration index and the precomputed amplitude weight are based on the sample time, the midpoint between source position Pₛ and receiver position Pᵣ, the offset between source position Pₛ and receiver position Pᵣ, and the velocity model, as discussed in connection with FIGS. 2 and 3. For example, row 425 may include migration index i₃, for example migration index 240 as discussed with reference to FIG. 2. Row 425 may also include amplitude weight w₃, discussed with reference to FIG. 3.

The contents of matrix 400 may be precomputed prior to performing a migration computation. In some embodiments, the contents of matrix 400 may be computed before the survey begins. In some embodiments, the contents of matrix 400 may be computed during the survey process.

In operation, matrix 400 may be used to construct a 3D migration image from the seismic traces as they are received. In some embodiments, the 3D migration image may be initialized to all zero values at the beginning of the survey operation. During the survey, matrix 400 may be used to migrate the samples of each seismic trace as it is received from the seismic receiver. For example, when trace 100, discussed with reference to FIG. 1, is received, the position of the seismic source that corresponds to trace 100 may be position Pₛ, and the position of the receiver that corresponds to trace 100 may be position Pᵣ. In such an example, matrix cell 410 may be selected and list 420 retrieved. The migration indexes and amplitude weights stored in list 420 may be used to migrate the samples of trace 100. For example, the sample of trace 100 taken at time t₃ may be shifted in time by migration index i₃ (stored in row 425 of list 420) and weighted by amplitude weight w₃ (stored in row 425 of list 420). The migrated sample may then be added to the 3D migration image.

In some embodiments, upon receipt of a seismic trace, the positions of the seismic source and seismic receiver corresponding to the trace may differ from the discretized positions used to index matrix 400. In such an embodiment, matrix 400 may be referenced using a discretized source position that approximates the actual source position and a discretized receiver position that approximates the actual receiver position. For example, the closest discretized position may be selected. However, any suitable method of quantizing the source and receiver positions may be used.

Although the present disclosure discusses using an indexed matrix for pre-stack time migration of seismic traces, an indexed matrix may also be used to migrate stacked traces after stacking is complete. In addition, other corrections and adjustments to seismic traces can also be accelerated in a similar fashion. For example, in some embodiments, a normal moveout correction may be applied to a seismic trace prior to stacking. In such embodiments, the normal moveout correction values may be stored in matrix 400. For example, the normal moveout correction for seismic source position Pₛ and receiver position Pᵣ may be calculated using the velocity model and stored in another column of list 420. During operation, the seismic source position and receiver position for each trace may be discretized as described above. The normal moveout correction values in the cell of matrix 420 corresponding to those discretized positions may then be retrieved and applied to the seismic trace before it is added to the stack.

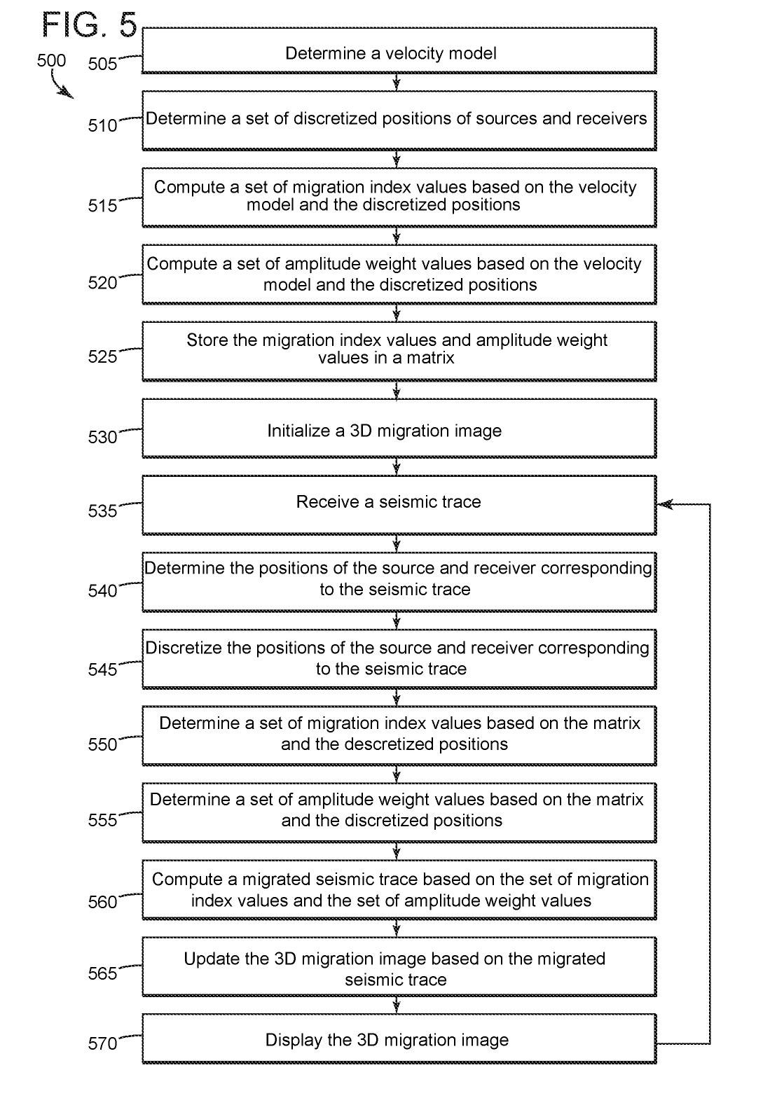

FIG. 5 illustrates a flow chart of an example method 500 for performing seismic migration using an indexed matrix in accordance with some embodiments of the present disclosure. The steps of method 500 can be performed by a user, electronic or optical circuits, various computer programs, models, or any combination thereof, configured to perform seismic migration using an indexed matrix. The programs and models may include instructions stored on a non-transitory computer-readable medium and operable to perform, when executed, one or more of the steps described below. The computer-readable media can include any system, apparatus, or device configured to store and retrieve programs or instructions such as a hard disk drive, a compact disc, flash memory, or any other suitable device. The programs and models may be configured to direct a processor or other suitable unit to retrieve and execute the instructions from the computer readable media. Collectively, the user, circuits, or computer programs and models used to perform seismic migration using an indexed matrix may be referred to as a “processing tool.” For example, the processing tool may be a computer located on a survey ship.

At step 505, the processing tool determines a velocity model. For example, the velocity model may represent the velocity at which seismic signals propagate through the subsurface at various points in the survey area, as discussed in connection with FIG. 1. The velocity model may vary as a function of depth below the surface, surface location, direction of propagation, or other suitable factors. In addition, the velocity model may be defined by the survey operators, estimated based on previous surveys of the survey area, or calculated in any other suitable manner. Although specific velocity models are discussed in the present disclosure, any suitable velocity model may be used.

At step 510, the processing tool determines a set of discretized positions of sources and receivers used to index a matrix. For example, in a land-based survey, the processing tool may determine a set of positions in a grid spaced approximately 8 meters apart and covering the surface of the survey area, as discussed in connection with FIG. 4. As another example, in a marine survey, the processing tool may determine a set of discretized positions in a grid spaced approximately 25 meters apart and covering the surface of water in the survey area, as discussed in connection with FIG. 4.

At step 515, the processing tool computes a set of migration index values. For example, the processing tool may calculate a set of migration index values for each time t in seismic trace 200, discussed with reference to FIG. 2, based on the velocity model, the location of the shot point of the seismic traces represented by graph 200, and the offset xᵣ between the seismic source and the receiver for seismic trace 110, discussed with reference to FIG. 1, and the time t. For example, the processing tool may compute the set of migration index values i₀, . . . iₙ stored in row 425 of list 420 in matrix 400, discussed with reference to FIG. 4. In some embodiments, the processing tool may calculate a set of migration index values for each pair of discretized source and receiver positions used to index matrix 400. In some embodiments, one or more migration index values may be computed before the survey begins. In some embodiments, one or more migration index values may be computed during the survey process.

At step 520, the processing tool computes a set of amplitude weight values. For example, the processing tool may calculate a set of amplitude weight values for each time t in seismic trace 200, discussed with reference to FIG. 2, based on the velocity model, the offset xᵣ between the seismic source and the receiver for seismic trace 110, discussed with reference to FIG. 1, and the time t. For example, the processing tool may compute the set of amplitude weight values w₀ . . . wₙ stored in row 425 of list 420 in matrix 400, discussed with reference to FIG. 4. In some embodiments, the processing tool may calculate a set of amplitude weight values for each pair of discretized source and receiver positions used to index matrix 400. In some embodiments, one or more amplitude weight values may be computed before the survey begins. In some embodiments, one or more amplitude weight values may be computed during the survey process.

At step 525, the processing tool stores the migration index values and the amplitude weight values in the matrix. For example, the processing tool may store the set of migration index values i₀ . . . iₙ and the set of amplitude weight values w₀ . . . wₙ in row 425 of list 420 in matrix 400, discussed with reference to FIG. 4. Furthermore, to increase processing speed, the processing tool may store matrix 400 on a solid-state hard-drive or in RAM. However, the processing tool may use any suitable storage medium to store matrix 400.

At step 530, the processing tool initializes a 3D migration image. For example, the processing tool may initialize all values in a 3D migration image to zero.

At step 535, the processing tool receives a seismic trace. For example, the processing tool may receive seismic trace 100, discussed with reference to FIG. 1.

At step 540, the processing tool determines the positions of the source and receiver corresponding to the seismic trace. For example, the position of the source and receiver corresponding to seismic trace 100 may be determined using GPS at the time seismic trace 100 is recorded.

At step 545, the processing tool discretizes the positions of the sources and receivers corresponding to the seismic trace. For example, as discussed with reference to FIG. 4, the processing tool may select discretized source position Pₛ because it is the closest discretized source position to the position of the source that corresponds to seismic trace 100. Similarly, the processing tool may select discretized receiver position Pᵣ because it is the closest discretized receiver position to the position of the source that corresponds to seismic trace 100.

At step 550, the processing tool determines a set of migration index values based on the index matrix and the discretized positions of the sources and receivers corresponding to the seismic trace. For example, the processing tool may retrieve list 420 from cell 410 of matrix 400, discussed with reference to FIG. 4. The processing tool may then retrieve migration index values i₀ . . . iₙ stored in row 425 of list 420.

At step 555, the processing tool determines a set of amplitude weight values based on the amplitude weight matrix and the discretized positions of the sources and receivers corresponding to the seismic data. For example, the processing tool may retrieve amplitude weight values w₀ . . . wₙ stored in row 425 of list 420.

At step 560, the processing tool computes a migrated seismic trace based on the set of migration index values, the set of amplitude weight values, and the seismic data. For example, the processing tool may shift each sample in time using the corresponding migration index stored in row 425 of list 420. For example, the processing tool may shift the sample at point 223, discussed with reference to FIG. 2, from time t₃ to time tₘ based on migration index i₃. The processing tool may multiply each sample in the seismic trace by the corresponding amplitude weight stored in row 425 of list 420. For example, the processing tool may multiply the sample at migrated point 233 (corresponding to time tₘ) by amplitude weight w₃.

At step 565, the processing tool updates the 3D migration image. For example, the processing tool may add the migrated seismic trace to the 3D migration image. For example, the processing tool may add each migrated sample computed in step 560 to the 3D migration image at a point determined by the source and receiver positions of the seismic trace and the time of the sample. In some embodiments, the processing tool updates only a portion of the 3D migration image. For example, the processing tool may update only the portion of the 3D migration image corresponding to a crossline section that the operation desires to view.

At step 570, the processing tool displays the 3D migration image. For example, the processing tool may render a portion of the 3D migration image on a computer display. In some embodiments, the portion of the 3D migration image rendered includes one or more of a time slice of the 3D migration image, an inline vertical slice of the 3D migration image, and a cross-line vertical slice of the 3D migration image. However, any suitable portion of the 3D migration image may be displayed. The processing tool then returns to step 535.

Modifications, additions, or omissions may be made to method 500 without departing from the scope of the present disclosure. For example, the steps may be performed in a different order than that described and some steps may be performed at the same time. Further, more steps may be added or steps may be removed without departing from the scope of the disclosure.

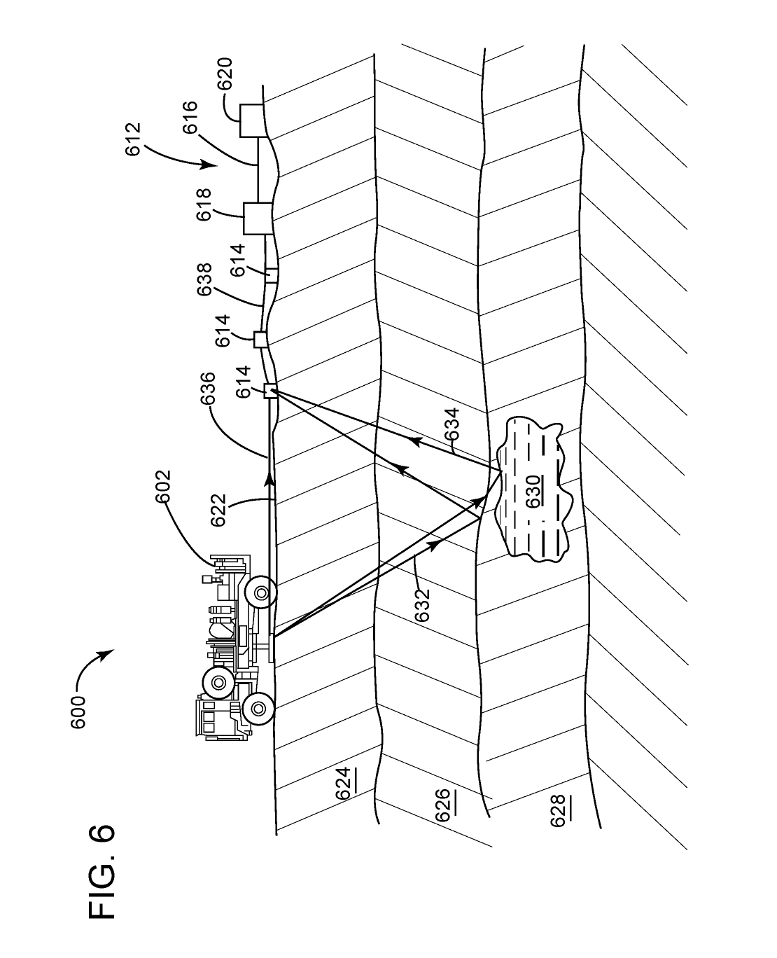

FIG. 6 illustrates an elevation view of an example seismic exploration system 600 configured to perform seismic migration using an indexed matrix in accordance with some embodiments of the present disclosure. The images produced by system 600 allow for the evaluation of subsurface geology. Seismic data is acquired and processed to produce images of subsurface formations. System 600 includes one or more seismic energy sources 602 and one or more receivers 614 which are located within a pre-determined area selected for seismic survey or exploration. Survey of the exploration area includes the activation of seismic energy source 602 that applies a force which in turn generates elastic waves that propagate through the earth. The seismic energy is then partially reflected, refracted, diffracted, and otherwise returned by one or more subsurface formations such as rock layers beneath the earth's surface, producing a motion recorded by receivers 614.

System 600 includes one or more seismic energy sources 602. In some embodiments, source 602 is located on or proximate to surface 622 of the earth within an exploration area. A particular source 602 may be spaced apart from other adjacent sources 602. Further, a positioning system, such as a global positioning system (GPS), may be utilized to locate sources 602 and receivers 614 and time-stamp their recordings.

Source 602 is any type of seismic device that generates controlled seismic energy used to perform reflection seismic surveys, such as a land-based or marine seismic vibrator, dynamite, an air gun, or any other suitable seismic energy source.

Seismic exploration system 600 includes one or more monitoring devices 612 that operate to record reflected seismic energy 632, 634, and 636. In some embodiments, monitoring device 612 includes one or more receivers 614, network 616, recording unit 618, and processing unit 620. Monitoring device 612 may be located remotely from source 602.

In some embodiments, receiver 614 is located on or proximate to surface 622 of the earth within an exploration area. Receiver 614 is any type of instrument that is operable to transform seismic energy or vibrations into a measurable signal. For example, receiver 614 may be a geophone configured to detect and record seismic velocity displacement reflected from subsurface formations and convert the motions into electrical energy, such as electric voltages. Receiver 614 may include a vertical, horizontal, or multicomponent geophone such as a three component (3C) geophone. Receiver 614 may include a 3C Digital Sensor Unit (DSU), an optical fiber sensor, or a distributed acoustic sensor (DAS). As another example, receiver 614 may include a hydrophone configured to detect and record pressure variations. In some embodiments, multiple receivers 614 are utilized within an exploration area to provide data related to multiple locations and distances from sources 602. For example, system 600 may utilize two thousand receivers (or geophones) 614. Receivers 614 may be positioned in multiple configurations, such as linear, grid, array, or any other suitable configuration. In some embodiments, receivers 614 are positioned along one or more strings 638. Each receiver 614 is typically spaced apart from adjacent receivers 614 in the string 138. Spacing between receivers 614 in string 138 may be approximately the same preselected distance, or span, or the spacing may vary depending on a particular application, exploration area topology, or any other suitable parameter. For example, spacing between receivers 614 may be approximately ten meters.

In some embodiments, one or more receivers 614 transmit raw seismic data from reflected seismic energy via network 616 to recording unit 618. Recording unit 618 transmits raw seismic data to processing unit 620 via network 616. Processing unit 620 performs seismic migration on the raw seismic data to prepare the data for interpretation. For example, processing unit 620 may be configured to perform one or more steps of method 500 and may include a processing tool as discussed in connection with FIG. 5. Processing unit 620 may also display the resulting 3D migration image to operators of the seismic survey for use in real time or near-real time quality control of the survey operation. Although discussed separately, recording unit 618, and processing unit 620 may be configured as separate units or as a single unit. Recording unit 618 or processing unit 620 may include any instrumentality or aggregation of instrumentalities operable to compute, classify, process, transmit, receive, store, display, record, or utilize any form of information, intelligence, or data. For example, recording unit 618 and processing unit 620 may include one or more personal computers, storage devices, servers, or any other suitable device and may vary in size, shape, performance, functionality, and price. Recording unit 618 and processing unit 620 may include random access memory (RAM), one or more processing resources, such as a central processing unit (CPU) or hardware or software control logic, or other types of volatile or non-volatile memory. Additional components of recording unit 618 and processing unit 620 may include one or more disk drives, one or more solid-state disk drives, one or more network ports for communicating with external devices, and one or more input/output (I/O) devices, such as a keyboard, a mouse, or a video display. Recording unit 618 or processing unit 620 may be located in a station truck or any other suitable enclosure.

Network 616 communicatively couples one or more components of monitoring device 612 with any other component of monitoring device 612. For example, network 616 communicatively couples receivers 614 with recording unit 618 and processing unit 620. Furthermore, network 638 communicatively couples a particular receiver 614 with other receivers 614. Although discussed separately, network 616, network 638, and network 616 may be configured as separate networks or as a single network. Network 616, network 638, and network 616 may be any type of network that provides communication. For example, network 616 may include one or more of a wireless network, a local area network (LAN), or a wide area network (WAN), such as the Internet.

In some embodiments, sources 602 are controlled to generate energy and receivers 614 record seismic energy traveling along paths 632 and 634 and reflected by interfaces between subsurface layers 624, 626, and 628, oil and gas reservoirs, such as target reservoir 630, or other subsurface formations. Subsurface layers 624, 626, and 628 may have various densities, thicknesses, or other characteristics. Target reservoir 630 may be separated from surface 622 by multiple layers 624, 626, and 628. Because the embodiment depicted in FIG. 6 is exemplary only, there may be more or fewer layers 624, 626, or 628 or target reservoirs 630.

The seismic survey may be repeated at various time intervals to determine changes in target reservoir 630. The time intervals may be months or years apart. Data may be collected and organized based on offset distances, such as the distance between a particular source 602 and a particular receiver 614 and the amount of time it takes for seismic energy traveling along paths 632 and 634 from source 602 to a particular receiver 614. The amount of time seismic energy takes to reach a receiver is known as the travel time. Data collected during a survey by receivers 614 is reflected in traces that may be gathered, processed, and utilized to generate a model of the subsurface formations.

Although discussed with reference to a land implementation, embodiments of the present disclosure are also useful in marine applications. In a marine application, monitoring device 612 may include hydrophones contained inside buoyant streamers, which may be towed behind a vessel. Seismic energy source 602 and monitoring device 612 may be towed behind the same or a different vessel. Similarly, in a marine application, recording unit 618 and processing unit 620 may include one or more computers aboard the vessel.

Although the present disclosure discusses seismic migration in the context of a survey operation, embodiments of the present disclosure may be used in permanent or continuous monitoring operations without departing from the scope of the present disclosure.

Any of the steps, operations, or processes described herein may be performed or implemented with one or more hardware or software modules, alone or in combination with other devices. In some embodiments, a software module is implemented with a computer program product comprising a computer-readable medium containing computer program code, which can be executed by a computer processor for performing any or all of the steps, operations, or processes described.

Embodiments of the disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability. For example, the processing tool described in method 500 with respect to FIG. 5 may be stored in tangible computer readable storage media.

Although the present disclosure has been described with several embodiments, changes, variations, alterations, transformations, and modifications may be suggested to one skilled in the art, and it is intended that the present disclosure encompass such changes, variations, alterations, transformations, and modifications as fall within the scope of the appended claims. Moreover, while the present disclosure has been described with respect to various embodiments, it is fully expected that the teachings of the present disclosure may be combined in a single embodiment as appropriate. Instead, the scope of the disclosure is defined by the appended claims.

What is claimed is:

1. A method comprising:
receiving a seismic trace from a receiver;
determining a discretized position of the receiver;
determining a discretized position of a seismic source;
determining a set of migration indexes based on a matrix, the discretized position of the receiver, and the discretized position of the seismic source;
determining a set of amplitude weights based on the matrix, the discretized position of the receiver, and the discretized position of the seismic source; and
migrate the seismic trace based on the set of migration indexes and the set of amplitude weights.

2. The method of claim 1, wherein determining the set of migration indexes comprises retrieving the set of migration indexes from the matrix.

3. The method of claim 1, further comprising
determining a set of discretized source positions;
determining a set of discretized receiver positions;
computing a set of migration indexes based on the discretized source positions and the set of discretized receiver positions;
computing a set of amplitude weights based on the discretized source positions and the set of discretized receiver positions; and
storing the migration indexes and the amplitude weights in the matrix.

4. The method of claim 3, wherein computing the set of migration indexes is further based on a velocity model.

5. The method of claim 3, wherein determining the discretized position of the receiver comprises selecting a closest position from the set of discretized receiver positions.

6. The method of claim 1, further comprising updating a 3D migration image based on the migrated seismic trace.

7. The method of claim 6, further comprising displaying the 3D migration image.

8. A seismic data acquisition system comprising:
a processor;
a memory communicatively coupled to the processor;
a receiver configured to transform seismic signals into seismic traces;
a seismic source;
a matrix stored in the memory; and
instructions stored in the memory that, when executed by the processor, cause the processor to:
receive a seismic trace from the receiver;
determine a discretized position of the receiver;
determine a discretized position of the seismic source;
determine a set of migration indexes based on the matrix, the discretized position of the receiver, and the discretized position of the seismic source;
determine a set of amplitude weights based on the matrix, the discretized position of the receiver, and the discretized position of the seismic source; and
migrate the seismic trace based on the set of migration indexes and the set of amplitude weights.

9. The seismic data acquisition system of claim 8, wherein determining the set of migration indexes comprises retrieving the set of migration indexes from the matrix.

10. The seismic data acquisition system of claim 8, the instructions further causing the processor to:
determine a set of discretized source positions;
determine a set of discretized receiver positions;
compute a set of migration indexes based on the discretized source positions and the set of discretized receiver positions;
compute a set of amplitude weights based on the discretized source positions and the set of discretized receiver positions; and
store the migration indexes and the amplitude weights in the matrix.

11. The seismic data acquisition system of claim 3, wherein computing the set of migration indexes is further based on a velocity model.

12. The seismic data acquisition system of claim 3, wherein determining the discretized position of the receiver comprises selecting a closest position from the set of discretized receiver positions.

13. The seismic data acquisition system of claim 8, the instructions further causing the processor to update a 3D migration image based on the migrated seismic trace.

14. The seismic data acquisition system of claim 13, the instructions further causing the processor to display the 3D migration image.

15. A non-transitory computer-readable medium, comprising instructions that, when executed by a processor, cause the processor to:
receive a seismic trace from a receiver;
determine a discretized position of the receiver;
determine a discretized position of a seismic source;
determine a set of migration indexes based on a matrix, the discretized position of the receiver, and the discretized position of the seismic source;
determine a set of amplitude weights based on the matrix, the discretized position of the receiver, and the discretized position of the seismic source; and
migrate the seismic trace based on the set of migration indexes and the set of amplitude weights.

16. The non-transitory computer-readable medium of claim 15, wherein determining the set of migration indexes comprises retrieving the set of migration indexes from the matrix.

17. The non-transitory computer-readable medium of claim 15, the instructions further causing the processor to:
determine a set of discretized source positions;
determine a set of discretized receiver positions;
compute a set of migration indexes based on the discretized source positions and the set of discretized receiver positions;
compute a set of amplitude weights based on the discretized source positions and the set of discretized receiver positions; and
store the migration indexes and the amplitude weights in the matrix.

18. The non-transitory computer-readable medium of claim 17, wherein computing the set of migration indexes is further based on a velocity model.

19. The non-transitory computer-readable medium of claim 17, wherein determining the discretized position of the receiver comprises selecting a closest position from the set of discretized receiver positions.

20. The non-transitory computer-readable medium of claim 15, the instructions further causing the processor to:
update a 3D migration image based on the migrated seismic trace; and
display the 3D migration image.
